(19) United States
(12) Patent Application Publication
(10) Pub. No.: US 2020/0060492 A1
(43) Pub. Date: Feb. 27, 2020

(54) BATTERY

(71) Applicant: TTi (Macao Commercial Offshore) Limited, Macau (CN)

(72) Inventors: Jacob Wayne Connelly, Concord, NC (US); Patrick Diana, Davidson, NC (US)

(21) Appl. No.: 16/545,576

(22) Filed: Aug. 20, 2019

Related U.S. Application Data
(60) Provisional application No. 62/720,504, filed on Aug. 21, 2018.

(51) Int. Cl. A47L 9/28; H01M 2/10; H01M 8/04746

(52) U.S. Cl. CPC A47L 9/2884; H01M 8/04746; H01M 2/1055

(57) ABSTRACT

A battery includes a sealed battery housing. The sealed battery housing includes a base, an outer lid, a first seal member, an inner lid, a second seal member, a terminal body, and a third seal member. The first seal member is disposed between the base and the outer lid. The base and the outer lid are, therefore, in sealing engagement. The second seal member is disposed between the outer lid and the inner lid. The outer lid and the inner lid are, therefore, in sealing engagement. The third seal member is disposed between the inner lid and the terminal body. The inner lid and the terminal body are, therefore, in sealing engagement.

### CROSS-REFERENCE TO RELATED APPLICATIONS

This application claims the benefit of U.S. Provisional Patent Application No. 62/720,504, filed Aug. 21, 2018, the entire contents of which are incorporated by reference herein.

### BACKGROUND

The present disclosure relates to a battery. Particularly, the present disclosure relates to sealed batteries.

### SUMMARY

In one embodiment, the disclosure provides a battery. The battery includes a sealed battery housing. The sealed battery housing includes a base, an outer lid, a first seal member, an inner lid, a second seal member, a terminal body, and a third seal member. The first seal member is disposed between the base and the outer lid. The base and the outer lid are, therefore, in sealing engagement. The second seal member is disposed between the outer lid and the inner lid. The outer lid and the inner lid are, therefore, in sealing engagement. The third seal member is disposed between the inner lid and the terminal body. The inner lid and the terminal body are, therefore, in sealing engagement.

In another embodiment, the disclosure provides a battery including a battery housing. The battery housing includes a base. The base has a pressure relief aperture defined therein. The battery housing further includes an outer lid in sealing engagement with the base, an inner lid in sealing engagement with the outer lid, and a terminal body in sealing engagement with the inner lid. A seal layer is coupled to the base. The seal layer covers the pressure relief aperture and cooperates with the battery housing to define a sealed chamber. The seal layer fails if a pressure inside the battery housing exceeds a threshold pressure.

Other aspects of the disclosure will become apparent by consideration of the detailed description and accompanying drawings.

### BRIEF DESCRIPTION OF THE DRAWINGS

FIG. 1 illustrates a perspective view of a device including an embodiment of a battery removably coupled thereto.

FIG. 2 illustrates a perspective view of the battery.

FIG. 3 illustrates a right side elevation view of the battery.

FIG. 4 illustrates a front elevation view of the battery.

FIG. 5 illustrates a rear elevation view of the battery.

FIG. 6 illustrates a top plan view of the battery.

FIG. 7 illustrates a longitudinal cross-sectional elevation view of the battery.

FIG. 7A illustrates a detailed cross-sectional elevation view of the battery.

FIG. 8 illustrates a lateral cross-sectional elevation view of the battery.

FIG. 8A illustrates a detailed cross-sectional elevation view of the battery.

FIG. 9 illustrates an exploded perspective view of the battery.

FIG. 10 illustrates a bottom perspective view of the outer lid of the battery.

FIG. 11 illustrates a right side elevation view of the inner lid of the battery with the circuit board connected thereto.

FIG. 12 illustrates a perspective view of the inner lid with the circuit board connected thereto.

FIG. 13 illustrates an exploded perspective view of the inner lid and the circuit board.

FIG. 14 illustrates a perspective view of the base.

FIG. 15 illustrates a perspective view another embodiment of a battery with a label exploded therefrom.

FIG. 16 illustrates a right side elevation view of the battery of FIG. 15 with the label removed.

FIG. 17 illustrates a cutaway perspective view of the battery of FIG. 15 with the label removed.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

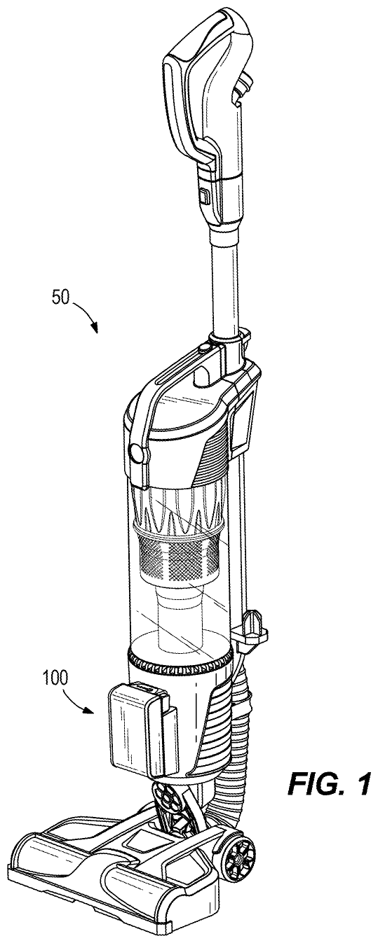

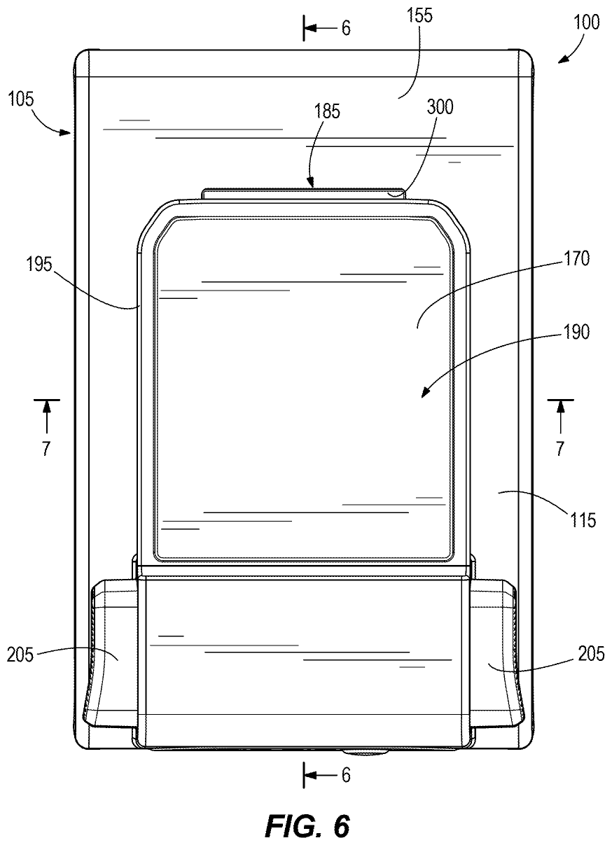

Referring to FIGS. 1-6, a battery 100 is shown. The battery 100 includes a sealed battery housing assembly 105. The sealed battery housing assembly 105 may be designed such that the battery 100 is watertight and/or airtight. Some embodiments of the battery 100 are, therefore, water-resistant or waterproof and may also be dustproof.

As shown in FIG. 1, the battery 100 can be removably attached to a device (or tool) 50, illustrated as an upright vacuum, selected from a number of compatible devices/tools. For instance, the battery 100 may be removably attached to a tool (e.g., drill, driver, saw, nailer, grinder, etc.), an outdoor tool (e.g., trimmer, pole saw, blower, etc.), an indoor tool (e.g., upright vacuum, handheld vacuum, etc.), other electrical tools (e.g., site light, power adapter, motorized device, non-motorized device, charger, etc.), and the like.

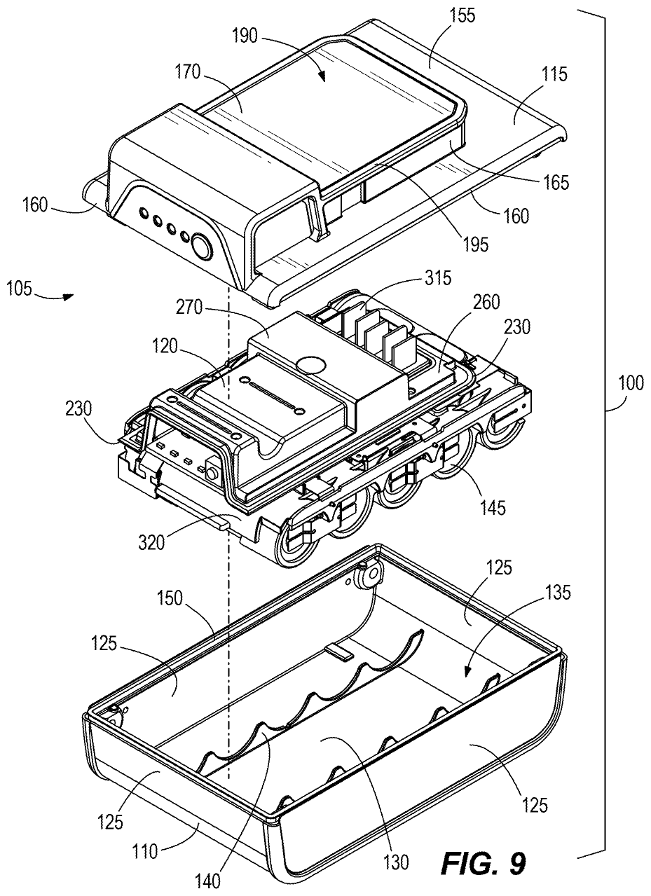

As best shown in FIG. 9, the battery housing assembly 105 includes a base 110, an outer lid 115, and an inner lid 120. Of course, the battery housing assembly 105 may be made of any appropriate material or combination of materials including, for instance, a polymer or metal material.

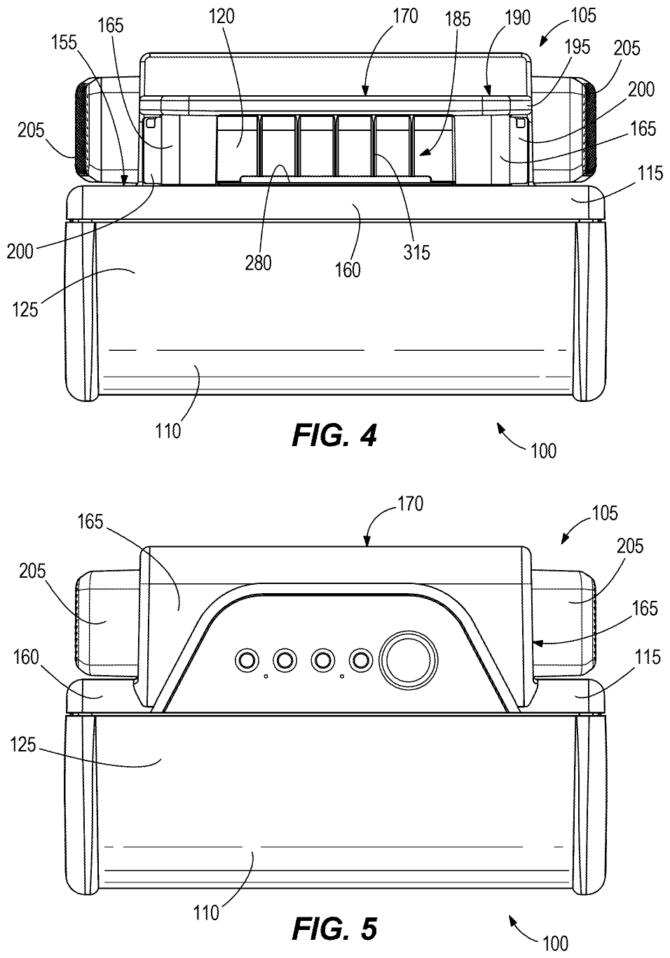

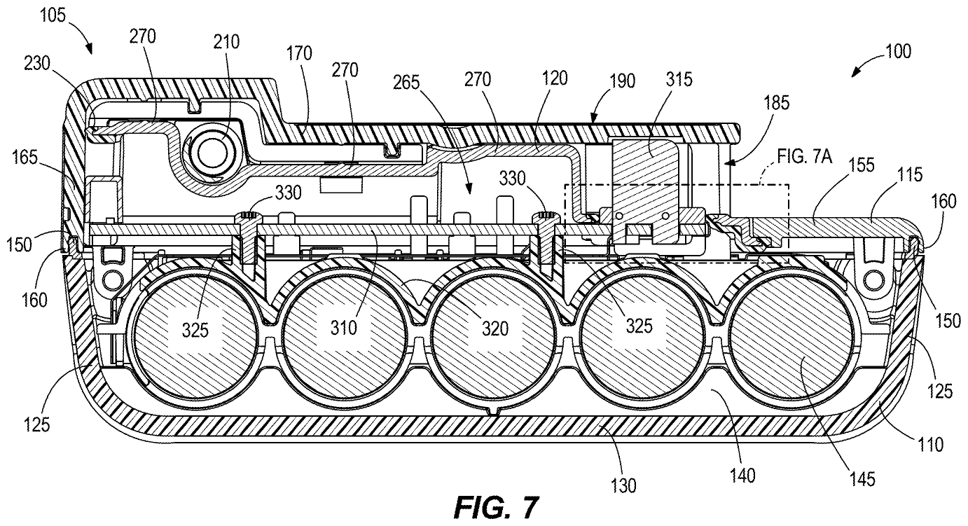

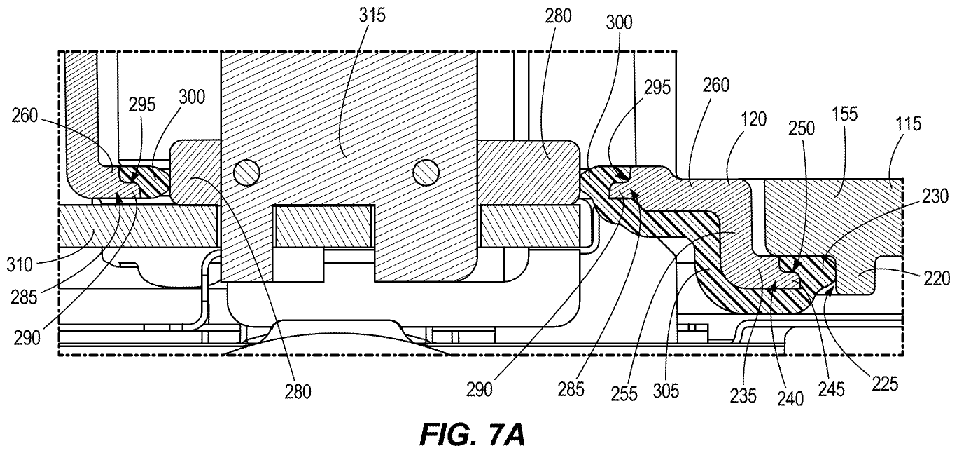

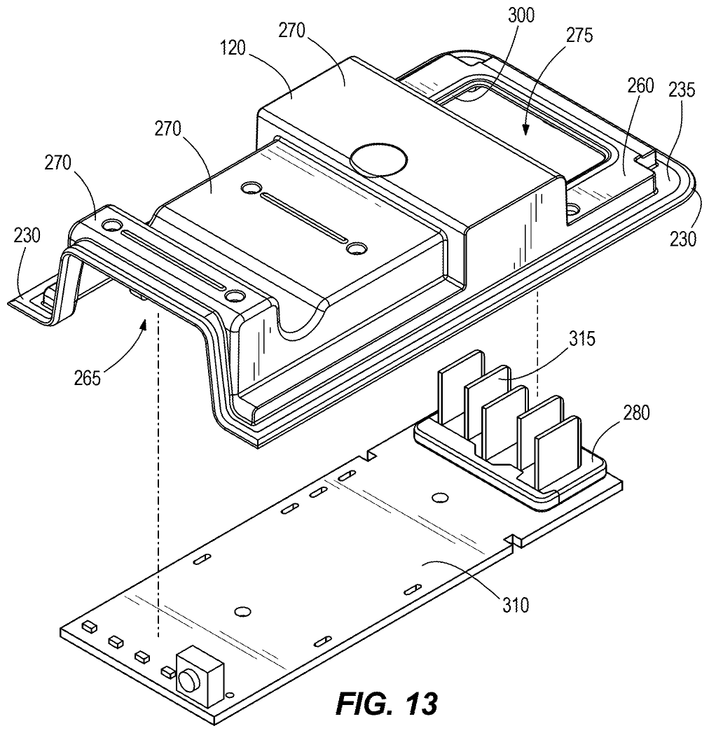

The battery 100 includes the housing assembly 105 enclosing a plurality of cells 145, an electronic circuit board 310, and one or more externally positioned electrical terminals 315. The housing assembly 105 may inhibit water ingress into the assembled housing. The housing assembly 105 includes the outer lid 115, the inner lid 120, and the base 110. The outer lid 115 and the inner lid 120 sealingly connect, forming a plug opening 185 providing access to the electrical terminals 315 but inhibiting water ingress through the plug opening into the housing. The base 110 is sealingly connected to the outer lid 115 with a first seal member 150 disposed between the base and the outer lid. The outer lid 115 is sealingly connected to the inner lid 120 with a second seal member 230 disposed between the outer lid and the inner lid. As shown in FIGS. 12 and 13, the battery 100 further includes a terminal body 280 with the one or more electrical terminals 315 positioned in the plug opening 185 (shown in FIG. 4) and in sealing engagement with the inner lid 120 (as shown in FIG. 7A). The one or more electrical terminals 315 are configured to engage corresponding electrical terminals on a corresponding device when the battery 100 is plugged into the corresponding device.

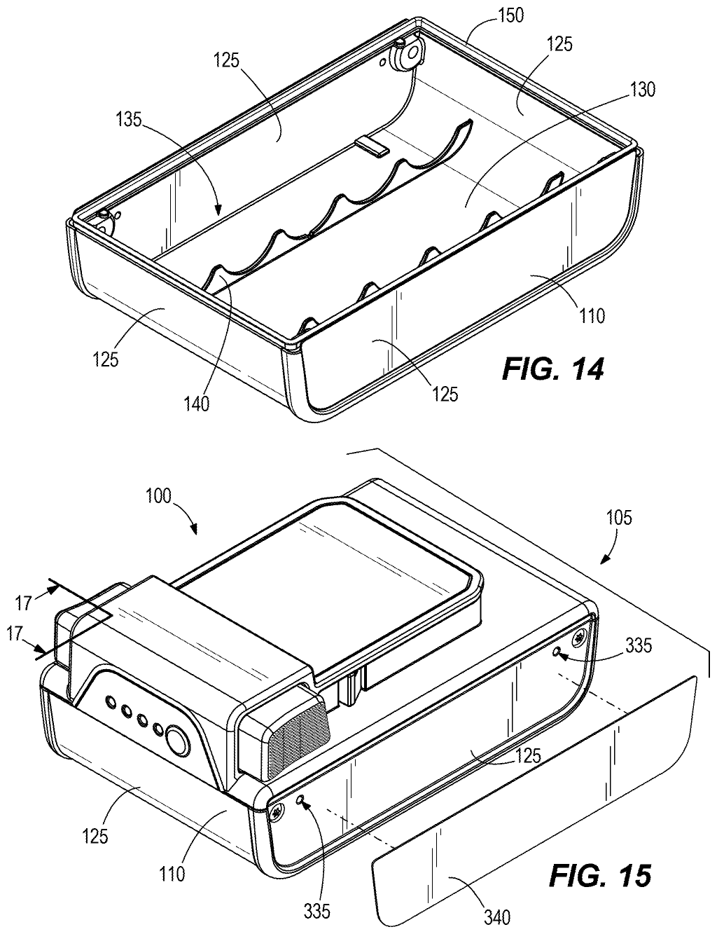

With particular reference to FIGS. 9 and 14, the base 110 includes a plurality of sidewalls 125. Embodiments of the base 110 having a single sidewall, such as a cylindrical base, for instance, are also contemplated herein. The base 110 also includes a floor 130. The floor 130 is connected to the one or more sidewalls 125 and may be integrally formed with the sidewalls. In some embodiments, one or more of the sidewalls 125 meet tangentially with the floor 130. Other sidewalls 125 may meet at an angle with the floor 130. A base cavity 135 is defined in the base. The base cavity 135 is at least partially surrounded by the sidewalls 125 and the floor 130.

In some embodiments, the base 110 further include one or more cell supports 140.

The cell supports 140 may be separate components from the base 110, or the cell supports may be integrally formed with the base. In some embodiments, the cell supports 140 are overmolded on the base 110 in the base cavity 135. In the illustrated embodiment, the cell supports 140 are overmolded on the floor 130 of the base 110 in the base cavity 135. The cell supports 140 may additionally or alternatively be overmolded on one or more of the sidewalls 125 of the base 110 in the base cavity 135.

Turning now to FIGS. 7, 8, and 9, the battery 100 further includes at least one battery cell 145 disposed in the battery housing assembly 105. In the illustrated embodiment, the at least one battery cell 145 is disposed in the base cavity 135 of the base 110. In embodiments including the cell supports 140, the battery cells 145 rest on the cell supports and are held in place in part due to the cell supports.

With reference to FIGS. 7-9 and 14, the battery housing assembly 105 further includes a first seal member 150. The first seal member 150 is disposed between the base 110 and the outer lid 115. The first seal member 150 is in sealing contact with both the base 110 and the outer lid 115 when the battery housing assembly 105 is assembled. With this arrangement, the base 110 and the outer lid 115 are in sealing engagement. The first seal member 150 may be a separate component from both the base 110 and the outer lid 115. In such embodiments, the first seal member 150 may be a discrete O-ring, some other shape ring, a sealing material layer deposited as a liquid or semi-liquid prior to assembly that solidifies after the battery housing assembly 105 has been assembled, and the like. In the illustrated embodiment, the first seal member 150 is overmolded on the base 110. The sealing engagement between the base 110 and the outer lid 115 are due to pressure of the respective parts against the first seal member 150 once the battery housing assembly 105 has been assembled. The first seal member 150 may be made of any appropriate material including, but not limited to, polymers, metals, wax, adhesive, and the like.

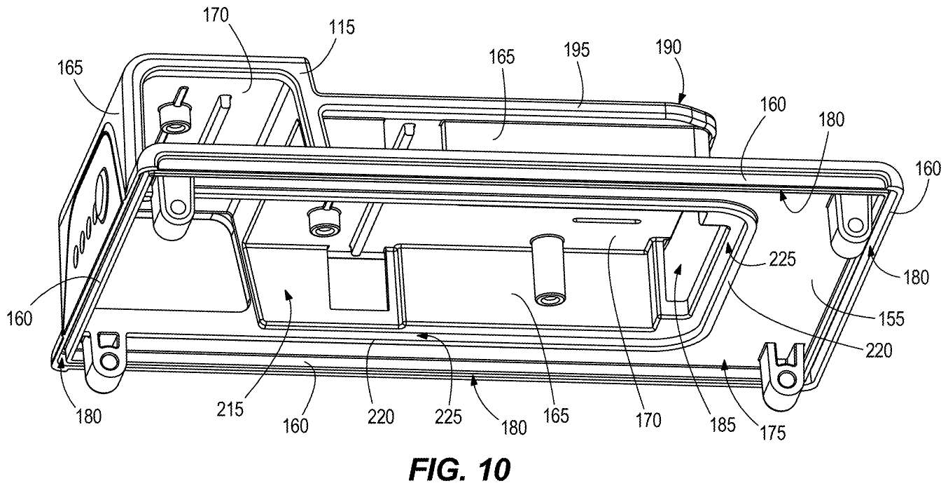

FIG. 10 illustrates the outer lid 115. The outer lid 115 includes a main wall 155 and a plurality of interface walls 160. The outer lid 115 further includes extension walls 165 that extend away from the main wall 155 and the interface walls 160. A ceiling 170 is attached to the extension walls 165. An outer lid cavity 175 is defined in the outer lid 115. The outer lid cavity 175 is at least partially surrounded by the main wall 155, the interface walls 160, the extension walls 165, and the ceiling 170. The outer lid 115 includes a groove 180 defined in the interface walls 160 at the ends of the respective interface walls. This groove 180 is dimensioned such that it receives a portion of the first seal member 150.

With reference to FIGS. 4 and 7, the outer lid 115 further includes a plug opening 185. The plug opening 185 is defined in at least one of the extension walls 165 to plug the battery 100 into a corresponding device. This plug opening 185 is discussed more below.

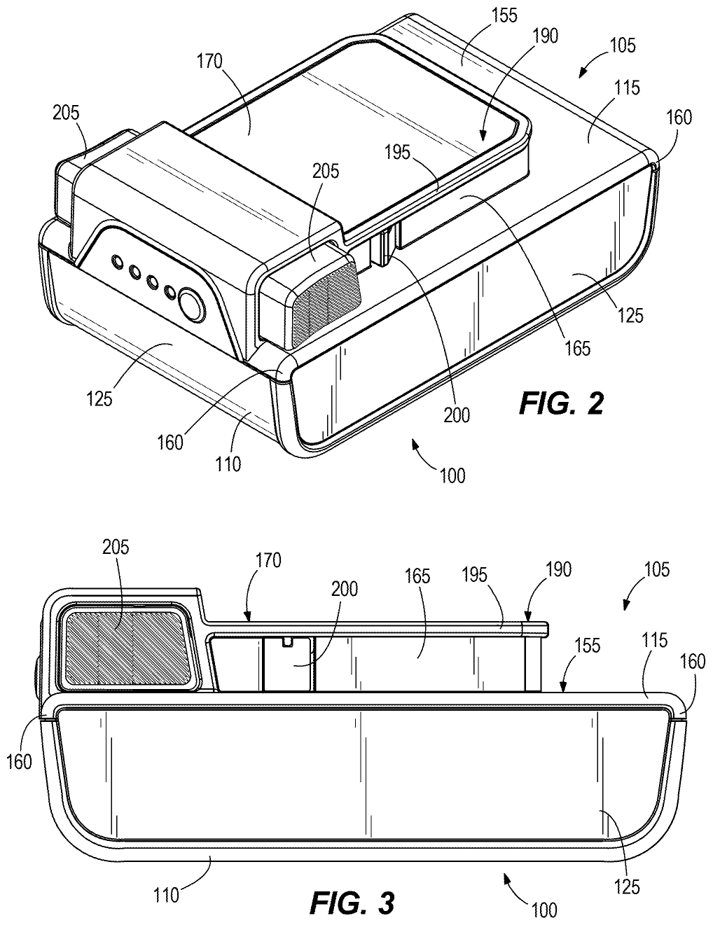

As shown best in FIGS. 2-4, the outer lid 115 also includes a slide-connect body 190. The slide-connect body 190 allows the battery 100 to slidably connect to a corresponding device. The slide-connect body 190 includes at least a portion of the extension walls 165 and the ceiling 170. The slide-connect body 190 further includes one or more guide rails 195 connected to at least one of the extension walls 165 and/or the ceiling 170.

The battery 100 further includes one or more detent mechanisms 200 operably connected to one or more corresponding user engagement buttons 205. In the illustrated embodiment, the battery 100 includes two detent mechanisms 200, and one user engagement button 205 is connected to each respective detent mechanism. A spring 210 biases the user engagement buttons 205 (and the corresponding detent mechanisms 200) toward a non-actuated position. As the battery 100 is slid into connection with a corresponding device 50 along the guide rails 195, the detent mechanisms 200 are pushed inward by the corresponding device until the battery is seated in a connected position and the spring presses the detent mechanisms outwardly to engage corresponding engagement features on the device. To remove the battery 100, the user presses the two user engagement buttons 205 together against the force of the spring 210. This action brings the two detent mechanisms 200 inward to allow release of the battery 100 from the engagement features on the corresponding device 50.

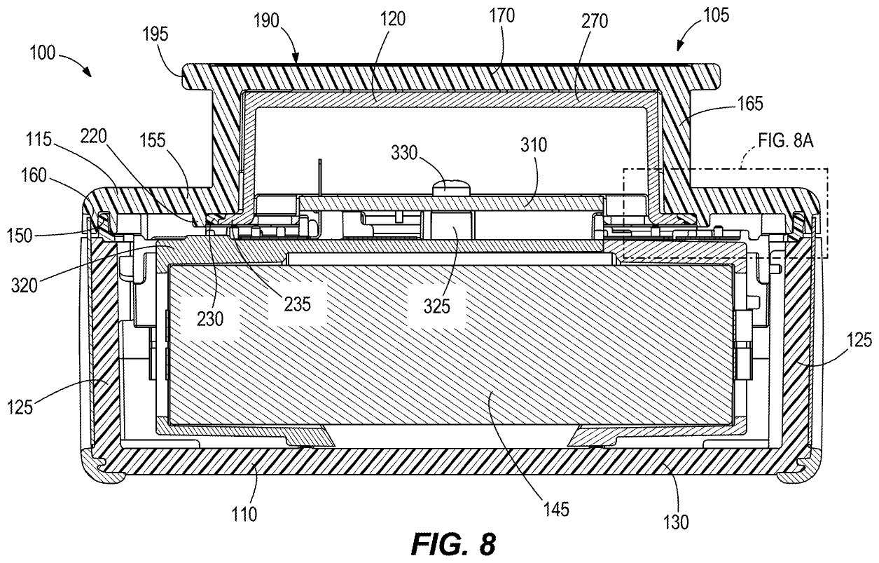

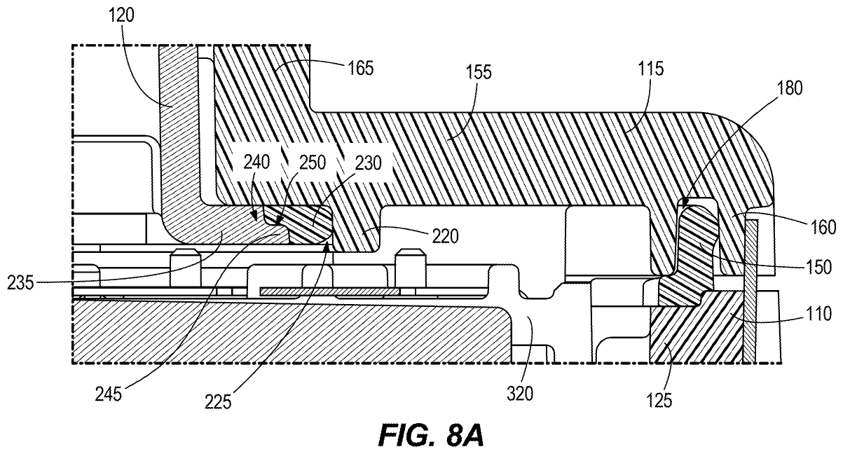

Referring again to FIG. 10, the outer lid 115 also includes a lid receiving cavity 215 defined therein. The lid receiving cavity 215 receives at least a portion of the inner lid 120. In the illustrated embodiment, the lid receiving cavity 215 is at least partially surrounded by the extension walls 165 and the ceiling 170 of the outer lid. A ridge, or protrusion, 220 extending from the main wall 155 at least partially surrounds the lid receiving cavity 215. As shown in FIG. 8A, the ridge 220 is set back from the lid receiving cavity 215 such that the main wall 155 and the ridge form an inwardly facing endwall surface 225 having an L-shaped cross section. Stated another way, the main wall 155 and the ridge 220 form an L-shaped interior endwall 225 facing inwardly.

Shown best in FIGS. 7-8A, the battery housing assembly 105 also includes a second seal member 230. The second seal member 230 is disposed between the outer lid 115 and the inner lid 120. The second seal member 230 is in sealing contact with both the outer lid 115 and the inner lid 120 when the battery housing assembly 105 is assembled. With this arrangement, the outer lid 115 and the inner lid 120 are in sealing engagement. The second seal member 230 may be a separate component from both the outer lid 115 and the inner lid 120. In such embodiments, the second seal member 230 may be a discrete O-ring, some other shape ring, a sealing material layer deposited as a liquid or semi-liquid prior to assembly that solidifies after the battery housing assembly 105 has been assembled, and the like. In the illustrated embodiment (as shown in FIG. 12), the second seal member 230 is overmolded on the inner lid 120. The sealing engagement between the outer lid 115 and the inner lid 120 is due to pressure of the respective parts against the second seal member 230 once the battery housing assembly 105 has been assembled. The second seal member 230 may be made of any appropriate material including, but not limited to, polymers, metals, wax, adhesive, and the like.

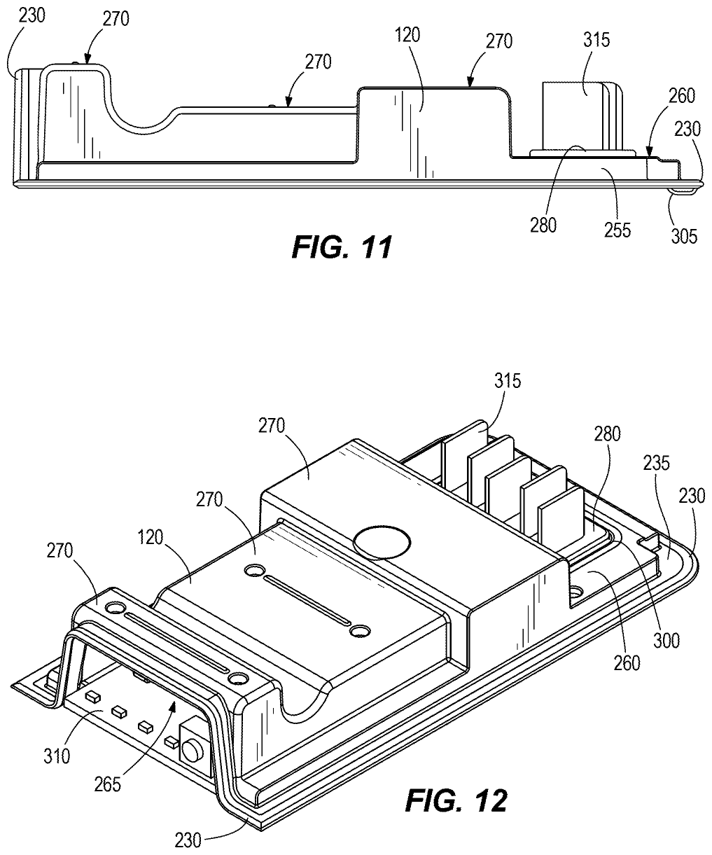

FIGS. 11-13 illustrate the inner lid 120. Shown best in FIG. 8A, the inner lid 120 includes a lateral extension 235 having a lateral extension end 240. The second seal member 230 is in sealing contact with the lateral extension 235 of the inner lid 120 and the L-shaped interior endwall 225 of the outer lid 115. In the illustrated embodiment, a finger member 245 protrudes from the lateral extension end 240 of the lateral extension 235. The lateral extension end 240 and the finger member 245 form an extension endwall 250. In the illustrated overmolded embodiment, the finger member 245 provides extended surface area for adherence of the second seal member 230 to the extension endwall 250. When the illustrated embodiment is assembled, the second seal member 230 sealingly contacts the L-shaped interior endwall 225 of the outer lid 115. Additionally, a portion of the seal 230 is captured between the finger member 245 and the L-shaped interior endwall 225 surface in sealing contact. Stated another way, the second seal member 230 sealingly contacts both the main wall 155 and the ridge 220 of the L-shaped interior endwall 225 of the outer lid 115 and sealingly contacts both the lateral extension end 240 and the finger member 245 of the L-shaped exterior endwall 250 of the inner lid 120. This configuration may aid in maintaining the second seal member 230 in proper sealing contact with both the outer lid 115 and the inner lid 120. The shape of the finger member 245 may vary to retain more or less of the second seal member 230 between the finger member and the L-shaped interior endwall surface 225 as desired for retention of the second seal member to the inner lid 120 and sealing contact between the lateral extension 235 and the L-shaped interior endwall surface.

Turning now to FIGS. 7A and 11, the inner lid 120 includes a plurality of platform sidewalls 255 connected to the lateral extension 235 and elevating a platform 260. With reference to FIG. 13, the inner lid 120 also includes an inner lid cavity 265 defined in the inner lid 120. The inner lid cavity 265 is at least partially surrounded by the platform sidewalls 255 and the platform 260. In some embodiments, the inner lid 120 further includes various elevated portions 270 dimensioned to contain various components in the inner lid cavity 265.

The inner lid 120 also includes a terminal opening 275 defined therein. The terminal opening 275 is dimensioned to receive a corresponding terminal body 280 disposed therein. The terminal opening 275 is bounded by the platform 260 of the inner lid 120. Stated another way, the terminal opening 275 is surrounded by a platform end 285, best shown in FIGS. 7 and 7A, of the platform 260 of the inner lid 120. In the illustrated embodiment, a finger member 290 protrudes from the platform end 285 of the platform 260. The platform end 285 and the finger member 290 form a platform end endwall 295 generally facing toward the terminal body 280. In the illustrated overmolded embodiment, the finger member 290 provides extended surface area for adherence of the third seal member 300 to the platform end endwall 295.

Shown best in FIGS. 7A and 13, the battery housing assembly 105 further includes a third seal member 300. The third seal member 300 is disposed between the inner lid 120 and the terminal body 280. In the illustrated embodiment, the third seal member 300 is disposed between the inner lid 120 and the terminal body 280 about the terminal opening 275. The third seal member 300 is in sealing contact with both the inner lid 120 and the terminal body 280 when the battery housing assembly 105 is assembled. With this arrangement, the inner lid 120 and the terminal body 280 are in sealing engagement. The third seal member 300 may be a separate component from both the inner lid 120 and the terminal body 280. In such embodiments, the third seal member 300 may be a discrete O-ring, some other shape ring, a sealing material layer deposited as a liquid or semi-liquid prior to assembly that solidifies after the battery housing assembly 105 has been assembled, and the like. In the illustrated embodiment (shown in FIG. 13), the third seal member 300 is overmolded on the inner lid 120. The third seal member 300 may be separate from the second seal member 230. In the illustrated embodiment, the third seal member 300 and the second seal member 230 are unitarily or integrally formed. Shown best in FIG. 7A, the third seal member 300 and the second seal member 230 are connected by a connection strip 305 of the seal material. The sealing engagement between the inner lid 120 and the terminal body 280 is due to pressure of the respective parts against the third seal member 300 once the battery housing assembly 105 has been assembled. The third seal member 300 may be made of any appropriate material including, but not limited to, polymers, metals, wax, adhesive, and the like.

Shown particularly in FIGS. 7 and 13, the terminal body 280 is also connected to a circuit board 310. In some embodiments, the circuit board 310 is a printed circuit board. The terminal body 280 further includes one or more electrical terminals 315 connected thereto. In the illustrated embodiment, the electrical terminals 315 are flat (e.g., blade-like) terminals. Alternatively, the electrical terminals 315 are receptacle (e.g., clip-like) terminals. These electrical terminals 315 project from the circuit board 310 into the outer lid cavity 175 in an area proximate the plug opening 185 of the outer lid 115 such that the electrical terminals are engaged by corresponding electrical terminals on a corresponding device 50 when the battery 100 is plugged into the corresponding device. The electrical terminals 315 are electrically connected to circuitry disposed on or in the circuit board 310. The circuit board 310 is at least partially disposed in the inner lid cavity 265. In the illustrated embodiment, the circuit board 310 is completely disposed in the inner lid cavity 265 and not in the base cavity 135. Stated another way, the circuit board 310 is disposed beyond the sidewalls 125 of the base 110 outside the base cavity 135.

Turning now to FIGS. 7 and 9, the battery 100 further includes a cell case 320 at least partially surrounding the battery cells 145. The cell case 320 may be a row of open-ended tubes that fit the battery cells 145 while leaving the ends of each battery cell accessible for circuitry. In the illustrated embodiment, the cell case 320 is a scalloped top plate with a series of recesses for fitting onto the row of battery cells 145. As shown in FIG. 7, the cell case 320 further includes one or more support posts 325. The support posts 325 are connected to the cell case 320. In the illustrated embodiment, the support posts 325 are unitarily or integrally formed with the cell case 320.

With reference to FIG. 7, one or more fasteners 330 passes through openings in the circuit board 310 and engage a respective support post 325 of the cell case 320. With this configuration, the inner lid 120 is connected to the terminal body 280, which, in turn, is connected to the circuit board 310, which, in turn, is connected to the cell case 320 by the fasteners 330. The cell case 320 may be either connected to or may simply rest upon the battery cells 145. Such a configuration may provide stabilization for the components disposed within the sealed battery housing assembly 105.

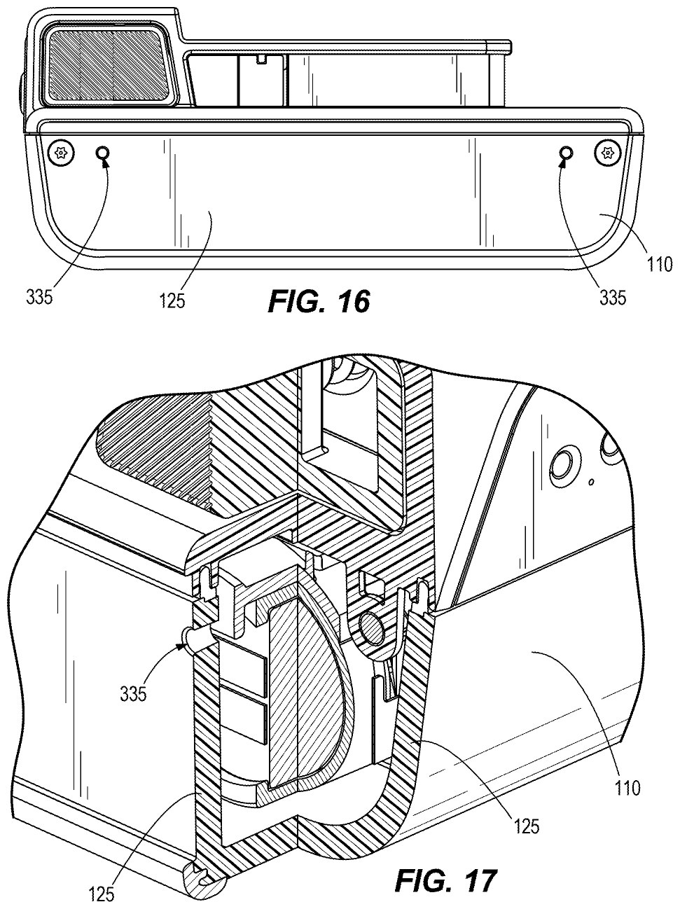

Turning now to FIGS. 15-17, the battery 100 may further include at least one pressure relief aperture 335. In the illustrated embodiment, the pressure relief apertures 335 are defined in at least one of the sidewalls 125 of the base 110. Some embodiments include two pressure relief apertures 335 defined in each of two opposing sidewalls 125 of the base 110. Of course, the pressure relief apertures 335 may be defined in any appropriate location, such as in another portion of the base 110, the outer lid 115, the inner lid 120, the terminal body 280, and the like. Any appropriate number of pressure relief apertures 335 may also be selected. As can best be seen in FIG. 17, each pressure relief aperture 335 is configured to communicate the base cavity 135 with the atmosphere outside the assembled battery 100. In the illustrated embodiment, each pressure relief aperture 335 includes a constant cross-sectional area as the pressure relief aperture extends through the sidewall 125 of the base 110. Further, the pressure relief apertures 335 are substantially or completely unobstructed through the sidewall 125 of the base 110. Stated another way, the pressure relief apertures 335 are without any valves or other components and are instead simply a bore through the sidewall 125. In the illustrated embodiment, the pressure relief apertures 335 are circular in cross-section. Any other appropriate shapes and sizes of the pressure relief apertures 335 are contemplated herein, and not all the pressure relief apertures need be uniform. The pressure relief apertures 335 may be formed in any appropriate manner including molding the components of the sealed battery housing assembly 105 with the apertures already defined therein, removing material from the housing assembly to form the apertures, and the like.

As shown in FIG. 15, the pressure relief apertures 335 are completely covered by at least one seal layer 340. The seal layer 340 may be made of any appropriate material and may be connected to the other portions of the sealed battery housing assembly 105 in any appropriate manner. In the illustrated embodiment, the seal layer 340 is connected to the sidewall 125 of the base 110 by adhesive disposed on the seal layer. Stated another way, the seal layer 340 is simply a label or decal that has adhesive uniformly on the entirety of one side to connect the seal layer to the sidewall 125. The seal layer 340 may include surface indicia or surface ornamentation on the face opposite the adhesive side. Although the present disclosure only illustrates the seal layer 340 disposed on an outside surface of the battery housing assembly 105, the current disclosure also contemplates a seal layer 340 additionally or alternatively disposed on an inner surface of any appropriate component of the battery housing assembly.

In embodiments of the battery 100 including the pressure relief aperture 335 and the seal layer 340, the battery housing assembly 105 remains sealed until the internal pressure of the assembly reaches a predetermined pressure threshold. Once the predetermined pressure threshold has been exceeded, the seal layer 340 may either burst or may at least partially release from the attachment face of the battery housing assembly 105 (in the illustrated embodiment, the sidewall 125). This predetermined pressure threshold may be selected to be a pressure value that is adequately below a damage pressure that would cause damage to the battery 100 if reached. As such, permanent damage to the sealed battery housing assembly 105 (or other components of the battery 100) may be avoided. The tuning of the predetermined pressure threshold causing a burst or release of the seal layer 340 may be accomplished by selecting a particular size or shape of the pressure relief aperture 335, selecting a particular material or materials of the seal layer, selecting a particular thickness of the adhesive, selecting a particular thickness of the seal layer, selecting a number of layers of material for the overall seal layer; any combination thereof, and the like. In some embodiments, the pressure relief aperture 335 is an aperture with a circular cross-section having a diameter of 0.5 to 3 millimeters.

Various features and advantages of the disclosure are set forth in the following claims.

What is claimed is:

1. A battery comprising:
a sealed battery housing assembly including
a base;
an outer lid;
a first seal member disposed between the base and the outer lid, the base and the outer lid in sealing engagement;
an inner lid;
a second seal member disposed between the outer lid and the inner lid, the outer lid and the inner lid in sealing engagement;
a terminal body; and
a third seal member disposed between the inner lid and the terminal body, the inner lid and the terminal body in sealing engagement.

2. The battery of claim 1, wherein
the inner lid further includes a terminal opening defined therein;
the terminal body is disposed in the terminal opening of the inner lid; and
the third seal member is disposed between the inner lid and the terminal body about the terminal opening.

3. The battery of claim 2, wherein the third seal member is unitarily formed with the second seal member.

4. The battery of claim 1, wherein
the outer lid includes a main wall and a ridge extending from the main wall, the main wall and the ridge forming an L-shaped interior endwall;
the inner lid includes a lateral extension; and
the second seal member is in sealing contact with the L-shaped interior endwall and the lateral extension of the inner lid.

5. The battery of claim 1, wherein the second seal member is in sealing contact with both the main wall and the ridge of the L-shaped interior endwall of the outer lid.

6. The battery of claim 1, wherein
the lateral extension of the inner lid further includes a lateral extension end; and
a finger member protrudes from the lateral extension end of the lateral extension.

7. The battery of claim 6, wherein a portion of the second seal member is captured between the finger member and the L-shaped interior endwall of the outer lid.

8. The battery of claim 6, wherein the second seal member is in sealing contact with both the lateral extension and the L-shaped interior endwall of the outer lid.

9. The battery of claim 1, further comprising
a base cavity defined in the base; and
at least one battery cell disposed in the base cavity.

10. The battery of claim 9, further comprising at least one cell support overmolded on the base in the base cavity, the at least one battery cell disposed on the at least one cell support.

11. The battery of claim 10, further comprising
a cell case at least partially surrounding the at least one battery cell; and
wherein the cell case includes a support post integrally formed therewith.

12. The battery of claim 11, further comprising
a circuit board disposed in the sealed battery housing; and
a fastener passing through the circuit board and engaging the support post of the cell case.

13. The battery of claim 1, further comprising a vacuum coupled to the battery.

14. A battery comprising:
a battery housing including
a base including a pressure relief aperture defined therein;
an outer lid in sealing engagement with the base;
an inner lid in sealing engagement with the outer lid; and
a terminal body in sealing engagement with the inner lid; and
a seal layer coupled to the base, the seal layer covering the pressure relief aperture and cooperating with the battery housing to define a sealed chamber, the seal layer configured to fail if a pressure inside the battery housing exceeds a threshold pressure.

15. The battery of claim 14, further comprising an adhesive coupling the seal layer to the base.

16. The battery of claim 15, wherein the seal layer is configured to fail such that the adhesive releases from the base to allow fluid communication between the sealed chamber and atmosphere.

17. The battery of claim 14, wherein the seal layer is configured to fail such that the seal layer bursts to allow fluid communication between the sealed chamber and atmosphere.

18. The battery of claim 14, wherein
the base includes a base sidewall; and
the pressure relief aperture is defined in the base sidewall.

19. The battery of claim 14, wherein the threshold pressure is above ambient pressure and below a pressure value which would damage a cell of the battery.

20. The battery of claim 14, further comprising a vacuum coupled to the battery.
